(19) United States
(12) Patent Application Publication
(10) Pub. No.: US 2013/0071820 A1
(43) Pub. Date: Mar. 21, 2013

(54) GEOGRAPHICALLY DRIVEN EDUCATIONAL GAME

(71) Applicant: Stephanie Esla, Bakersfield, CA (US)

(72) Inventor: Stephanie Esla, Bakersfield, CA (US)

(21) Appl. No.: 13/235,325

(22) Filed: Sep. 16, 2011

(51) Int. Cl. G09B 25/06

(52) U.S. Cl. 434/130

(57) ABSTRACT

Aspects for teaching geographic-specific are disclosed, which include apparatuses, methods, and computer-readable storage media to facilitate such teaching. For instance, in an exemplary embodiment, a response to a geographic-specific task is solicited and evaluated. A set of reward units is then adjusted based on an accuracy of the response, and a virtual travel experience is facilitated according to the accuracy.

### TECHNICAL FIELD

The subject disclosure generally relates to computerized games, and more specifically to a geographically-driven educational game.

### BACKGROUND

By way of background concerning conventional computer games, it is noted that such games often provide little educational value. Moreover, most of the more popular computer games lack an educational objective. For instance, fighting games are quite popular, wherein a frequent object of these games is to simply win a fight (e.g., via an accumulation of points, killing/defeating an adversary, etc.). Sports games are also popular, wherein the object of those games may be to simply win the sporting event (e.g., winning a football game).

For some computer games, although they might include an educational objective, such games often lack entertainment value. Indeed, games with an educational objective are often dry and static. Games that attempt to teach geography, for instance, may simply ask users to identify countries on a map.

Accordingly, it would be desirable to provide a dynamic educational game with entertainment value which overcomes these limitations. To this end, it should be noted that the above-described deficiencies are merely intended to provide an overview of some of the problems of conventional systems, and are not intended to be exhaustive. Other problems with the state of the art and corresponding benefits of some of the various non-limiting embodiments may become further apparent upon review of the following detailed description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

In accordance with one or more embodiments and corresponding disclosure, various non-limiting aspects are described in connection with teaching geographic-specific content in a computerized gaming environment. In one such aspect, a method to teach geographic-specific content is provided, which includes soliciting a response to a geographic-specific task. The method further includes evaluating the response, and adjusting a set of reward units based on an accuracy of the response. A virtual travel experience is then facilitated according to the accuracy of the response.

In another aspect, a computer-readable storage medium that facilitates teaching geographic-specific content is provided. For this embodiment, the computer-readable storage medium includes computer-readable instructions for causing at least one processor to perform various acts. Such acts include receiving an input responding to a geographic-specific task, and ascertaining an accuracy of the input. Further acts include updating a set of reward units based on the accuracy of the input, and displaying a virtual travel experience that varies according to the accuracy of the input.

In a further aspect, another computer-readable storage medium that facilitates teaching geographic-specific content is provided. Here, the computer-readable storage medium again includes computer-readable instructions for causing at least one processor to perform various acts. For this particular embodiment, such acts include receiving a plurality of inputs respectively corresponding to a plurality of geographic-specific tasks, and determining an accuracy of at least one of the plurality of inputs. A virtual travel experience that varies according to the accuracy of the at least one input is then displayed.

Other embodiments and various non-limiting examples, scenarios and implementations are described in more detail below.

### BRIEF DESCRIPTION OF THE DRAWINGS

Various non-limiting embodiments are further described with reference to the accompanying drawings in which:

FIG. 1 illustrates an exemplary environment that facilitates teaching geographic-specific content in accordance with an aspect of the subject specification;

FIG. 2 illustrates a block diagram of an exemplary gaming unit that facilitates teaching geographic-specific content in accordance with an aspect of the subject specification;

FIG. 3 illustrates an exemplary coupling of electrical components that effectuate teaching geographic-specific content according to a first embodiment;

FIG. 4 illustrates an exemplary coupling of electrical components that effectuate teaching geographic-specific content according to a second embodiment;

FIG. 5 illustrates an exemplary coupling of electrical components that effectuate teaching geographic-specific content according to a third embodiment;

FIG. 6 illustrates a flow diagram of an exemplary methodology for teaching geographic-specific content in accordance with an aspect of the subject specification;

FIG. 7 illustrates a first exemplary implementation of a gaming unit according to an embodiment;

FIG. 8 illustrates a second exemplary implementation of a gaming unit according to an embodiment;

FIG. 9 is a block diagram representing exemplary non-limiting networked environments in which various embodiments described herein can be implemented; and

FIG. 10 is a block diagram representing an exemplary non-limiting computing system or operating environment in which one or more aspects of various embodiments described herein can be implemented.

### DETAILED DESCRIPTION

### Overview

As discussed in the background, it is desirable to provide a dynamic educational game with entertainment value. The various embodiments disclosed herein are directed towards geographically-driven educational game, wherein users perform various geographic-specific tasks to facilitate a virtual travel experience. It is contemplated that such tasks may include any of a plurality of types of tasks including, but not limited to, answering geographic-specific questions (e.g., identifying the capital of country X), speaking in a geographic-specific language (e.g., speaking in the language spoken in country X), and performing a geographic-specific physical activity (e.g., performing a dance associated with country X). In an aspect, reward units are accumulated throughout the game, wherein such units are redeemable in either the virtual world (e.g., traveling the virtual world in vehicles that are upgradeable) and/or the real world (e.g., discounts on airfare, hotels, etc.).

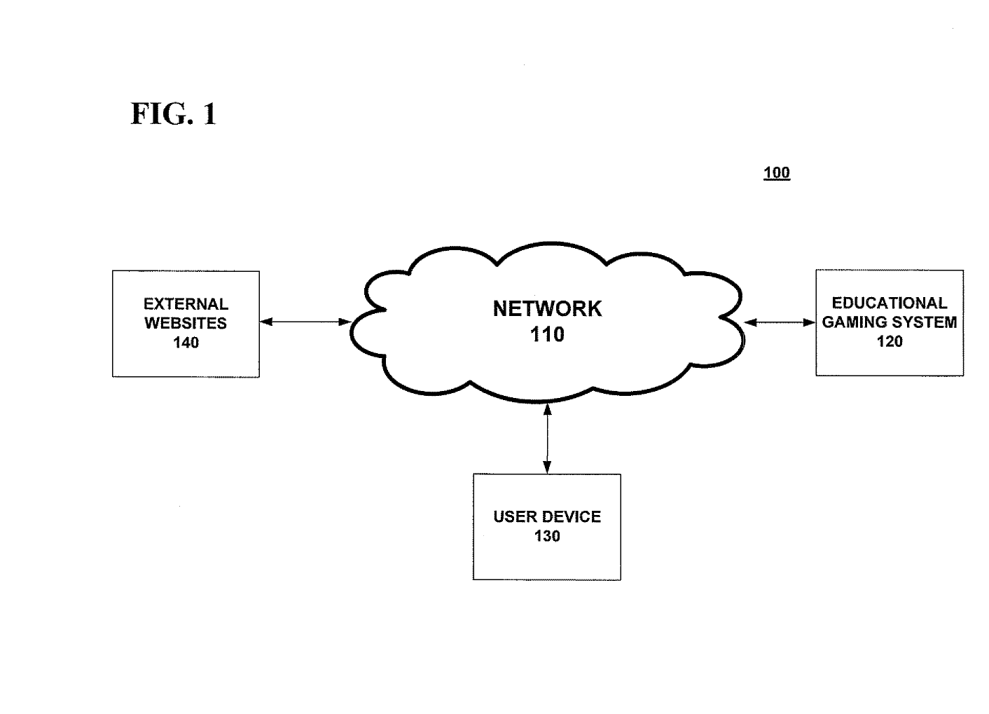

Turning now to FIG. 1, an exemplary environment that facilitates teaching geographic-specific content in accordance with an aspect of the subject specification is provided. As illustrated, environment 100 includes educational gaming system 120, which is coupled to user device 130 and external websites 140 via network 110. In one aspect, educational gaming system 120 is configured to host the aforementioned virtual travel experience, wherein a user may utilize user device 130 to perform geographic-specific tasks provided by educational gaming system 120. In another aspect, however, user device 130 alone can be used to run the virtual travel experience such that network 110 is not needed (e.g., where user device 130 is a gaming console). In yet another aspect, it is contemplated that external websites 140 can be provided with information associated with a user's progress in a game. For instance, a social media website may be automatically notified that a user successfully completed a set of virtual tasks in a particular country (e.g., via a wall post).

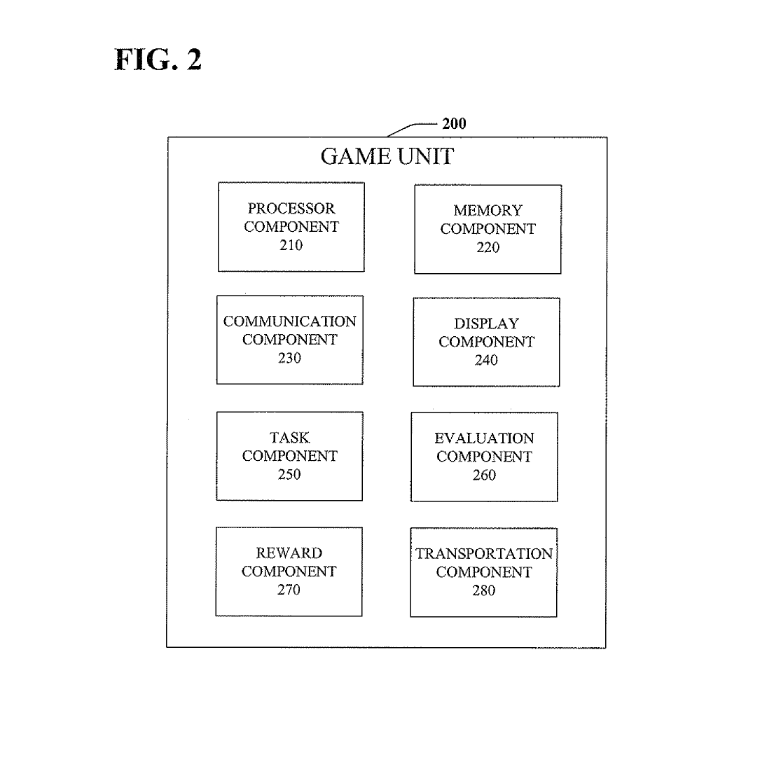

Referring next to FIG. 2, a block diagram of an exemplary gaming unit that facilitates teaching geographic-specific content according to an embodiment is illustrated. As shown, gaming unit 200 may include processor component 210, memory component 220, communication component 230, display component 240, task component 250, evaluation component 260, reward component 270, and transportation component 280.

In one aspect, processor component 210 is configured to execute computer-readable instructions related to performing any of a plurality of functions. Processor component 210 can be a single processor or a plurality of processors which analyze and/or generate information utilized by memory component 220, communication component 230, display component 240, task component 250, evaluation component 260, reward component 270, and/or transportation component 280. Additionally or alternatively, processor component 210 may be configured to control one or more components of gaming unit 200.

In another aspect, memory component 220 is coupled to processor component 210 and configured to store computer-readable instructions executed by processor component 210. Memory component 220 may also be configured to store any of a plurality of other types of data including data generated by any of communication component 230, display component 240, task component 250, evaluation component 260, reward component 270, and/or transportation component 280. Memory component 220 can be configured in a number of different configurations, including as random access memory, battery-backed memory, hard disk, magnetic tape, etc. Various features can also be implemented upon memory component 220, such as compression and automatic back up (e.g., use of a Redundant Array of Independent Drives configuration).

In yet another aspect, gaming unit 200 includes communication component 230, which is coupled to processor component 210 and configured to interface gaming unit 200 with external entities. For instance, communication component 230 may be configured to solicit and/or receive a response to a geographic-specific task. Within such embodiment, it is contemplated that a plurality of responses of various types can be solicited and/or received from a user of gaming unit 200. Accordingly, communication component 230 can be configured in any of a plurality of ways including, for example, as a motion-sensing input device, microphone, and/or keyboard.

As illustrated, gaming unit 200 may also include display component 240 and task component 250. Within such embodiment, display component 240 may be configured to display a virtual travel experience, whereas task component 250 may be configured to provider users with various tasks associated with the virtual travel experience. To this end, it should be appreciated that such tasks may be of various types including, for example, a geographic-specific question, a geographic-specific dance, and/or a geographic-specific language translation.

In another aspect, gaming unit 200 includes evaluation component 260, which is configured to ascertain an accuracy of responses to the various tasks. Here, it is contemplated that evaluation component 260 may be coupled to task component 250, wherein task component 250 is configured to increase/decrease a difficulty of subsequent tasks according to response accuracy. It is further contemplated that evaluation component 260 may be configured to determine a partial accuracy for some responses. Indeed, for some tasks, such as a geographic-specific dance and/or a geographic-specific language translation, a partial accuracy determination is desirable.

Gaming unit 200 may also include reward component 270, as shown. For these embodiments, reward component 270 is configured to update a set of reward units based on response accuracy. Here, it should be appreciated that such reward units may represent any of a plurality of unit types, wherein reward component 270 may be configured to aggregate reward units in a particular game and/or series of games. Reward units may, for example, represent points in a game, real/fictional currency, etc.

In a particular embodiment, communication component 230 may be configured to provide an external website with information associated with a user's reward units and/or progress in a game. For instance, a social media website may be automatically notified that a user successfully completed a set of virtual tasks in a particular country (e.g., via a wall post). In another embodiment, a travel-related website may be provided with a user's aggregated point total, wherein such points are redeemable at the travel-related website for store credit (e.g., discounts on airfare, hotel, etc.).

In a further aspect, it is contemplated that virtual travel experiences are facilitated by virtual transportation of various types. Accordingly, gaming unit 200 may further include transportation component 280, which is configured to provide such transportation. In one embodiment, for example, transportation component 280 is configured to provide a geographic-specific virtual transportation mechanism (e.g., a bullet-train in Japan, a trolley in San Francisco, etc.). In another embodiment, transportation component 280 is configured to provide a virtual vehicle (e.g., car, helicopter, yacht, private jet, etc.), wherein such vehicles are upgradeable according an accumulation of reward units (e.g., upgrade from a standard car to a luxury car).

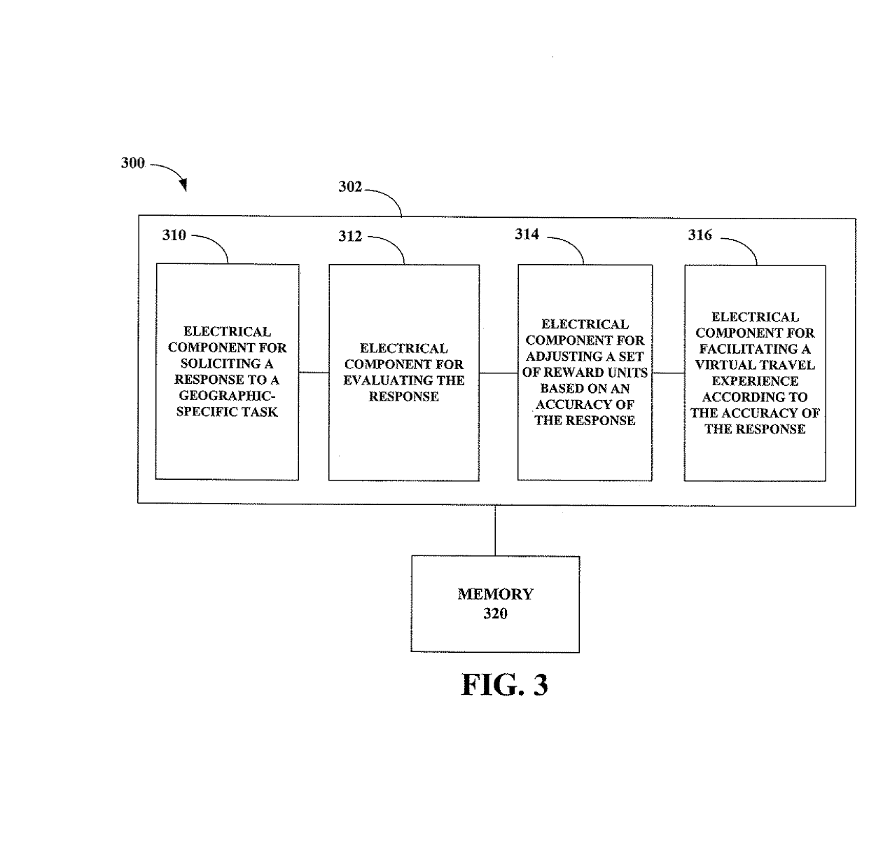

Turning to FIG. 3, illustrated is a system 300 that facilitates teaching geographic-specific content according to an embodiment. System 300 and/or instructions for implementing system 300 can reside within a computing device, for example. As depicted, system 300 includes functional blocks that can represent functions implemented by a processor using instructions and/or data from a computer readable storage medium. System 300 includes a logical grouping 302 of electrical components that can act in conjunction. As illustrated, logical grouping 302 can include an electrical component for soliciting a response to a geographic-specific task 310, as well as an electrical component for evaluating the response 312. Logical grouping 302 can also include an electrical component for adjusting a set of reward units based on an accuracy of the response 314. Further, logical grouping 302 can include an electrical component for facilitating a virtual travel experience according to the accuracy of the response 316. Additionally, system 300 can include a memory 320 that retains instructions for executing functions associated with electrical components 310, 312, 314, and 316. While shown as being external to memory 320, it is to be understood that electrical components 310, 312, 314, and 316 can exist within memory 320.

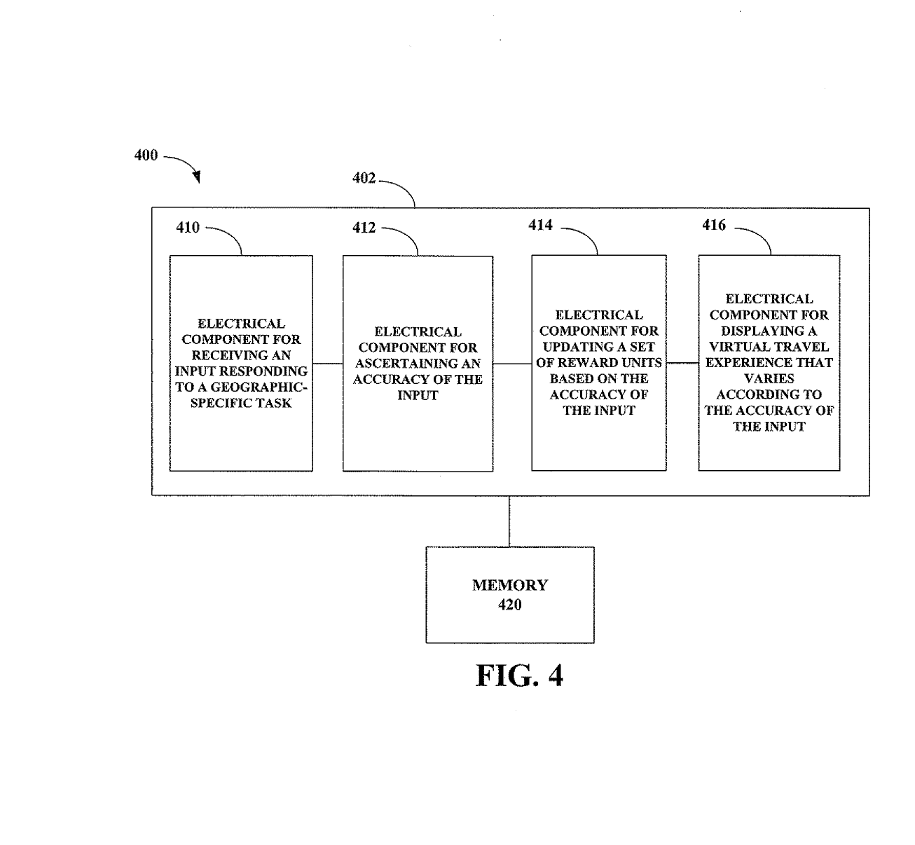

Referring next to FIG. 4, illustrated is another exemplary system 400 that facilitates teaching geographic-specific content according to an embodiment. System 400 and/or instructions for implementing system 400 can also physically reside within a computing device, for instance, wherein system 400 includes functional blocks that can represent functions implemented by a processor using instructions and/or data from a computer readable storage medium. System 400 includes a logical grouping 402 of electrical components that can act in conjunction similar to logical grouping 302 in system 300. As illustrated, logical grouping 402 can include an electrical component for receiving an input responding to a geographic-specific task 410, as well as an electrical component for ascertaining an accuracy of the input 412. Logical grouping 402 can also include an electrical component for updating a set of reward units based on the accuracy of the input 414. Further, logical grouping 402 can include an electrical component for displaying a virtual travel experience that varies according to the accuracy of the input 416. Additionally, system 400 can include a memory 420 that retains instructions for executing functions associated with electrical components 410, 412, 414, and 416, wherein it is to be understood that electrical components 410, 412, 414, and 416 can exist within memory 420 and/or external to memory 420.

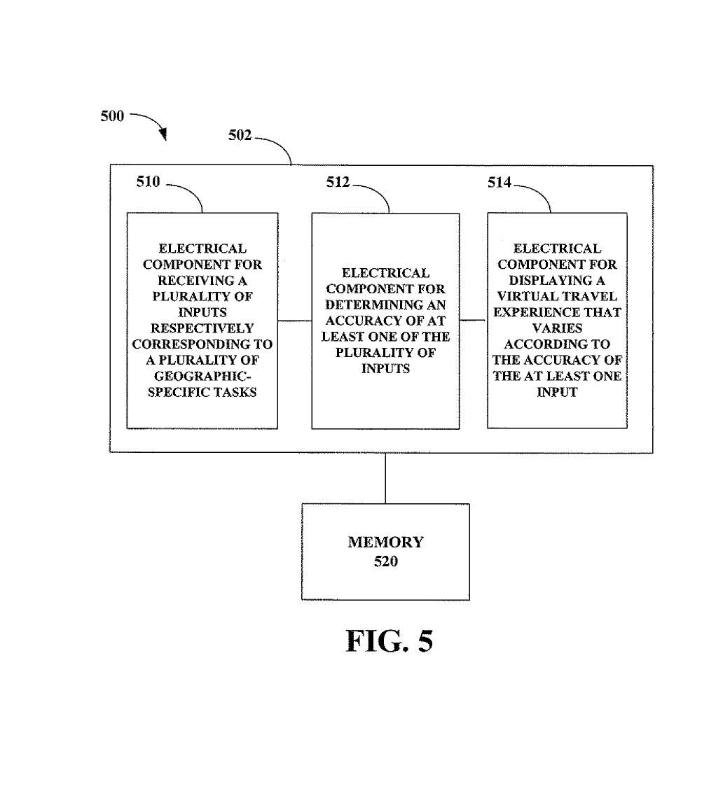

Referring next to FIG. 5, illustrated is yet another exemplary system 500 that facilitates teaching geographic-specific content. System 500 and/or instructions for implementing system 500 can again physically reside within a computing device, wherein system 500 includes functional blocks that can represent functions implemented by a processor using instructions and/or data from a computer readable storage medium. System 500 includes a logical grouping 502 of electrical components that can act in conjunction similar to logical groupings 302 and 402 respectively corresponding to systems 300 and 400. As illustrated, logical grouping 502 can include an electrical component for receiving a plurality of inputs respectively corresponding to a plurality of geographic-specific tasks 510. Furthermore, logical grouping 502 can include an electrical component for determining an accuracy of at least one of the plurality of inputs 512. Logical grouping 502 can also include an electrical component for displaying a virtual travel experience that varies according to the accuracy of the at least one input 514. As illustrated, system 500 can include a memory 520 configured to retain instructions for executing functions associated with electrical components 510, 512, and 514. While shown as being external to memory 520, it should again be appreciated that electrical components 510, 512, and 514 can exist within memory 520.

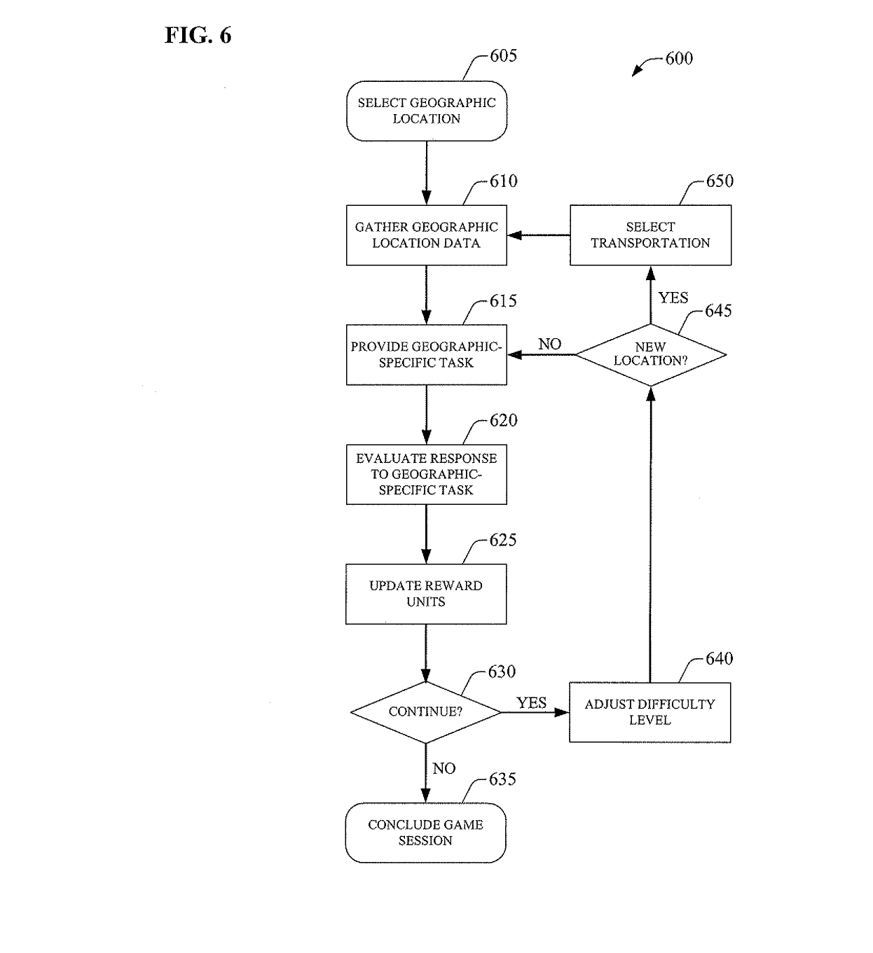

Referring next to FIG. 6, a flow chart illustrating an exemplary method to facilitate teaching geographic-specific content is provided. As illustrated, process 600 includes a series of acts that may be performed within a computing device (e.g., gaming unit 200) according to an aspect of the subject specification. For instance, process 600 may be implemented by employing a processor to execute computer executable instructions stored on a computer readable storage medium to implement the series of acts. In another embodiment, a computer-readable storage medium comprising code for causing at least one computer to implement the acts of process 600 are contemplated.

In an aspect, process 600 begins with a geographic location being selected at act 605. Here, it should be appreciated that such location may be selected by a player and/or randomly selected by the gaming unit. It should be further appreciated that the geographic location can be selected according to any of a plurality of geographic granularities (e.g., continent, country, state, city, etc.).

Once a geographic location has been selected, process 600 continues to act 610 where data corresponding to the selected geographic location is gathered. It is contemplated that data gathered at act 610 can include various types of data associated with the selected geographic location including, for example, cultural data, socioeconomic data, historical data, language data, etc.

Process 600 then proceeds to act 615 where a geographic-specific task is provided to the player(s) based on the data gathered at act 610. Here, it is noted that tasks provided to the player(s) may be selected randomly and/or according to player(s) input. For example, a player may be prompted to choose between a dance task, a language translation task, or question task. Alternatively, the gaming unit might randomly provide tasks of various types.

Once a task has been provided, process 600 then proceeds to act 620 where a response to the task is evaluated. To this end, although a binary evaluation might be adequate for some tasks (e.g., correct/incorrect), it is contemplated that a partial accuracy calculation may also be implemented (e.g., rating the accuracy of a dance and/or language translation task according to a tiered scale). Reward units can then be updated at act 625 according to the accuracy ascertained at act 620.

At act 630, a determination is then made of whether to continue with the gaining session. For instance, if a player does not wish to continue, process 600 concludes at act 635. Here, it should be noted that concluding the session at act 635 may include various tasks including, for example, saving game settings and communicating game activity to an external entity (e.g., a wall post on a social media site).

However, if the player has chosen to continue the gaming session, process 600 proceeds to act 640 where a difficulty level of subsequent tasks is adjusted. For instance, the difficulty level may become more/less difficult according to player accuracy. The player and/or gaming unit then determines whether to proceed to a new virtual geographic location. If a new location is not desired, process 600 loops back to act 615 where a new task is provided to the player. Otherwise, if a location is indeed desired, process 600 proceeds to act 650 where transportation for arriving to the new location is selected (e.g., public transportation, car, boat, jet, etc.). Once transportation is selected, process 600 loops back to act 610 where data corresponding to the newly selected location is gathered.

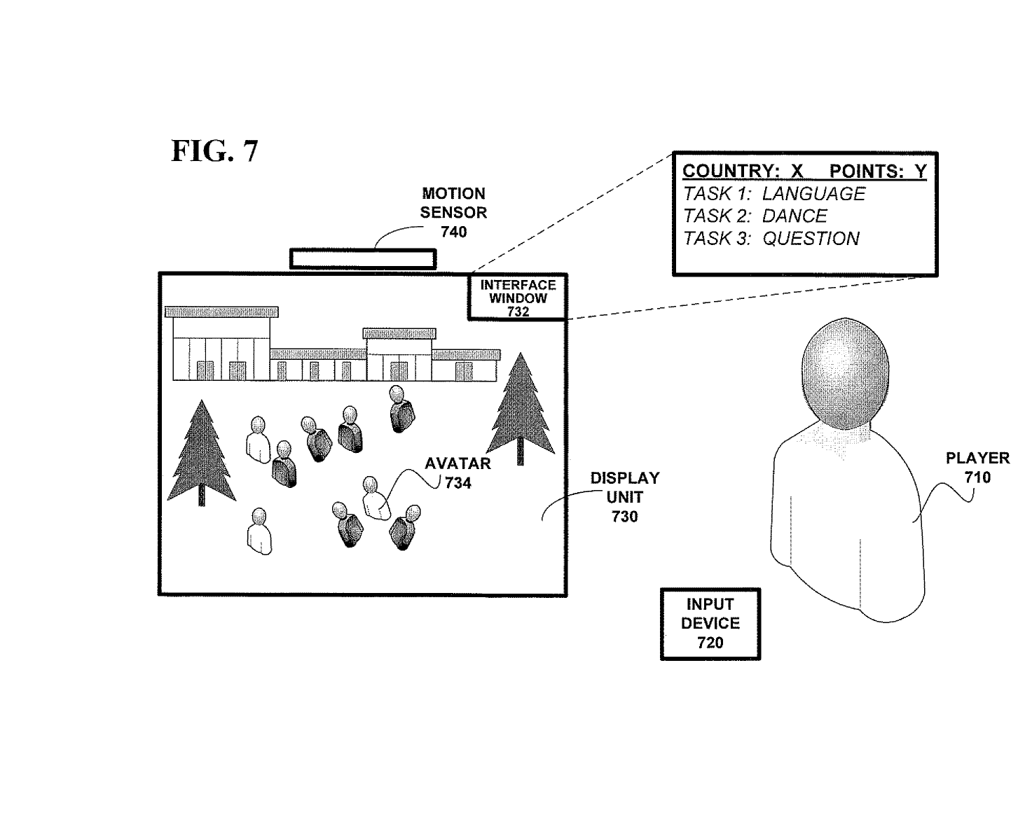

Referring next to FIG. 7, a first exemplary implementation of a gaming unit according to an embodiment is provided. As illustrated, a player 710 has a corresponding avatar 734 which travels through a virtual world displayed on display unit 730. Within such embodiment, it is contemplated that player 710 may be asked to perform various geographic-specific tasks displayed on interface window 732, as shown. To facilitate such tasks, it should be noted that responses may be provided via input device 720 (e.g., a microphone to facilitate a voice input responding to language-related task, a keyboard to facilitate typing responses to questions, etc.) and/or motion sensor 740 (e.g., to facilitate performing a dance-related task).

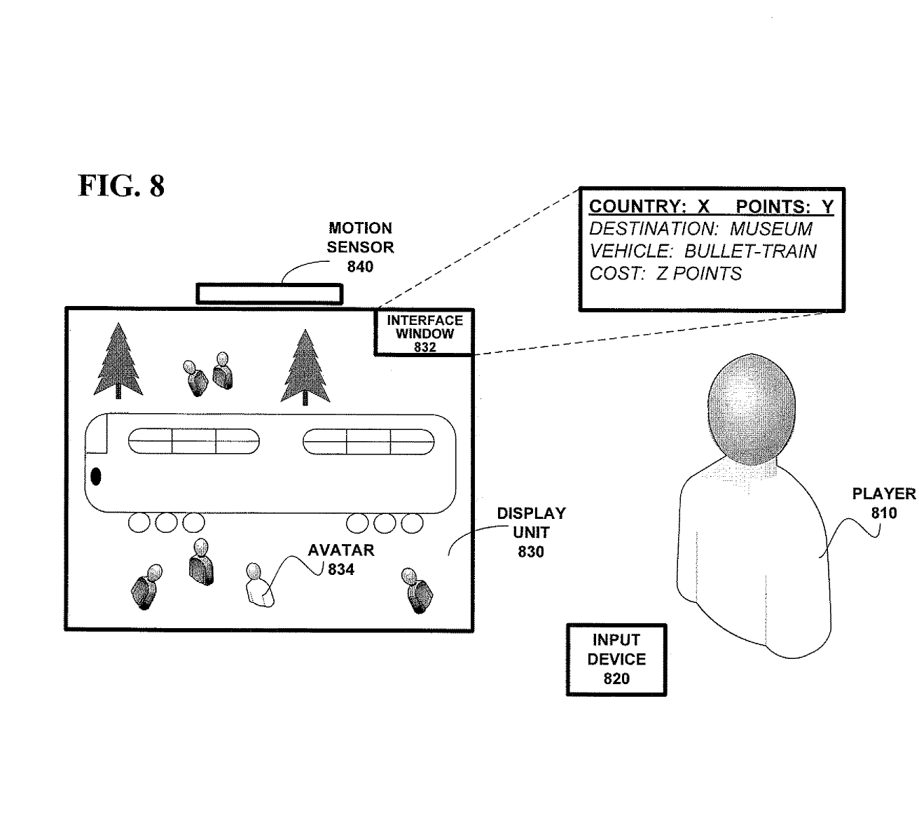

Referring next to FIG. 8, a second exemplary implementation of a gaming unit according to an embodiment is provided. Here, similar to FIG. 7, a player 810 has a corresponding avatar 834 displayed on display unit 830. For this particular example, interface window 832 is updated to reflect a virtual commute to a different location. Namely, for this example, player 810 is traveling to a museum via bullet-train, which costs Z points. To this end, it should be noted that a bullet-train might be specific to Country X, and the costs for traveling on such a bullet-train in Country X may be displayed in the actual currency of Country X. Upon arriving at the museum, player 810 may again be asked to perform various geographic-specific tasks, wherein responses to these tasks may be provided via input device 820 (e.g., a microphone to facilitate a voice input responding to language-related task, a keyboard to facilitate typing responses to questions, etc.) and/or motion sensor 840 (e.g., to facilitate performing a dance-related task).

### Exemplary Networked and Distributed Environments

One of ordinary skill in the art can appreciate that various embodiments for implementing the use of a computing device and related embodiments described herein can be implemented in connection with any computer or other client or server device, which can be deployed as part of a computer network or in a distributed computing environment, and can be connected to any kind of data store. Moreover, one of ordinary skill in the art will appreciate that such embodiments can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

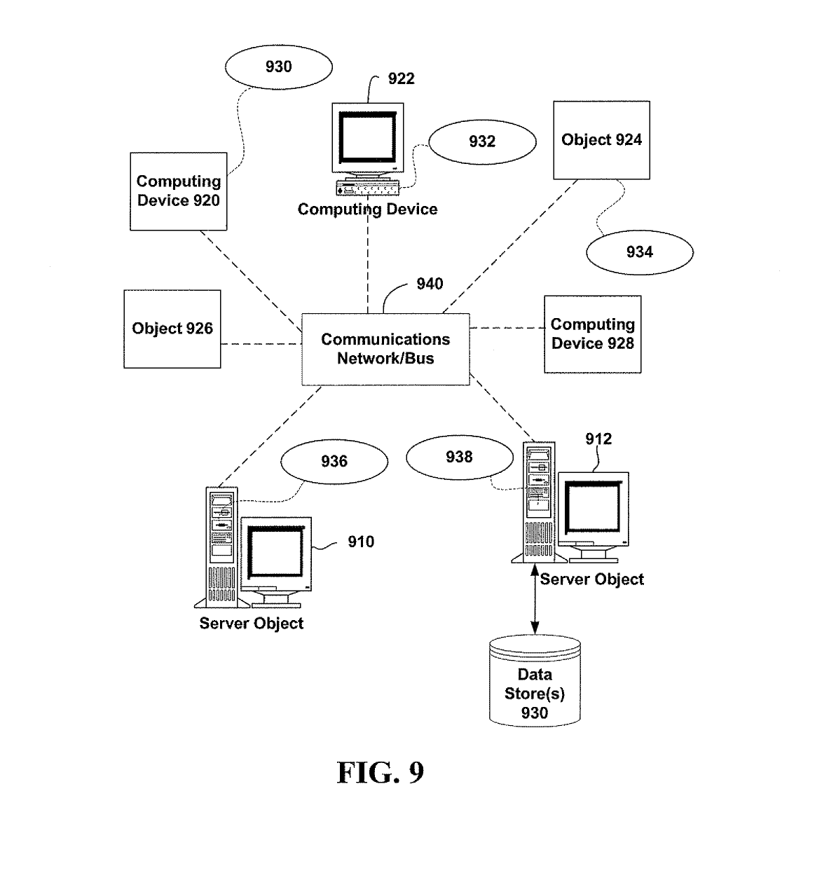

FIG. 9 provides a non-limiting schematic diagram of an exemplary networked or distributed computing environment. The distributed computing environment comprises computing objects or devices 910, 912, etc. and computing objects or devices 920, 922, 924, 926, 928, etc., which may include programs, methods, data stores, programmable logic, etc., as represented by applications 930, 932, 934, 936, 938. It can be appreciated that computing objects or devices 910, 912, etc. and computing objects or devices 920, 922, 924, 926, 928, etc. may comprise different devices, such as PDAs (personal digital assistants), audio/video devices, mobile phones, MP3 players, laptops, etc.

Each computing object or device 910, 912, etc. and computing objects or devices 920, 922, 924, 926, 928, etc. can communicate with one or more other computing objects or devices 910, 912, etc. and computing objects or devices 920, 922, 924, 926, 928, etc. by way of the communications network 940, either directly or indirectly. Even though illustrated as a single element in FIG. 9, network 940 may comprise other computing objects and computing devices that provide services to the system of FIG. 9, and/or may represent multiple interconnected networks, which are not shown. Each computing object or device 910, 912, etc. or 920, 922, 924, 926, 928, etc. can also contain an application, such as applications 930, 932, 934, 936, 938, that might make use of an API (application programming interface), or other object, software, firmware and/or hardware, suitable for communication with or implementation of an infrastructure for information as a service from any platform as provided in accordance with various embodiments.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the techniques as described in various embodiments.

Thus, a host of network topologies and network infrastructures, such as client/server, peer-to-peer, or hybrid architectures, can be utilized. In a client/server architecture, particularly a networked system, a client is usually a computer that accesses shared network resources provided by another computer, e.g., a server. In the illustration of FIG. 9, as a non-limiting example, computing objects or devices 920, 922, 924, 926, 928, etc. can be thought of as clients and computing objects or devices 910, 912, etc. can be thought of as servers where computing objects or devices 910, 912, etc. provide data services, such as receiving data from computing objects or devices 920, 922, 924, 926, 928, etc., storing of data, processing of data, transmitting data to computing objects or devices 920, 922, 924, 926, 928, etc., although any computer can be considered a client, a server, or both, depending on the circumstances. Any of these computing devices may be processing data, or requesting services or tasks that may implicate an infrastructure for information as a service from any platform and related techniques as described herein for one or more embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the user profiling can be provided standalone, or distributed across multiple computing devices or objects.

In a network environment in which the communications network/bus 940 is the Internet, for example, the computing objects or devices 910, 912, etc. can be Web servers with which the computing objects or devices 920, 922, 924, 926, 928, etc. communicate via any of a number of known protocols, such as HTTP. As mentioned, computing objects or devices 910, 912, etc. may also serve as computing objects or devices 920, 922, 924, 926, 928, etc., or vice versa, as may be characteristic of a distributed computing environment.

### Exemplary Computing Device

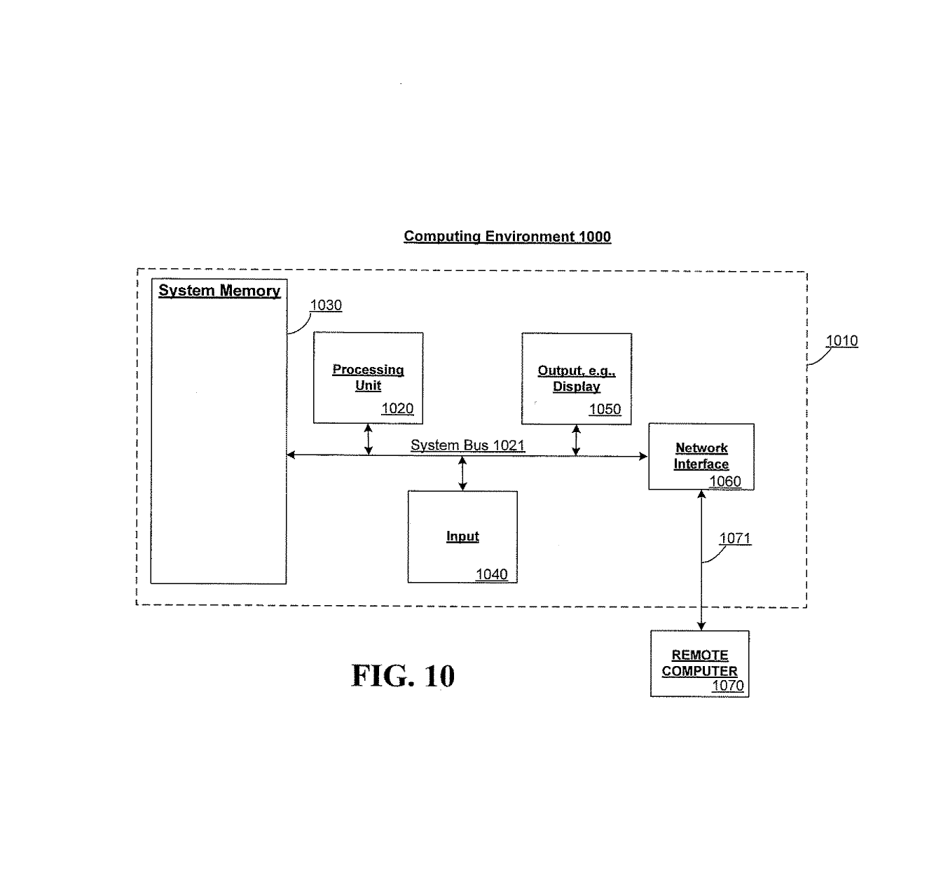

As mentioned, several of the aforementioned embodiments apply to any device wherein it may be desirable to include a computing device to teach geographic-specific content according to the aspects disclosed herein. It is understood, therefore, that handheld, portable and other computing devices and computing objects of all kinds are contemplated for use in connection with the various embodiments described herein, i.e., anywhere that a device may provide some functionality in connection with teaching geographic-specific content. Accordingly, the below general purpose remote computer described below in FIG. 10 is but one example, and the embodiments of the subject disclosure may be implemented with any client having network/bus interoperability and interaction.

Although not required, any of the embodiments can partly be implemented via an operating system, for use by a developer of services for a device or object, and/or included within application software that operates in connection with the operable component(s). Software may be described in the general context of computer executable instructions, such as program modules, being executed by one or more computers, such as client workstations, servers or other devices. Those skilled in the art will appreciate that network interactions may be practiced with a variety of computer system configurations and protocols.

FIG. 10 thus illustrates an example of a suitable computing system environment 1000 in which one or more of the embodiments may be implemented, although as made clear above, the computing system environment 1000 is only one example of a suitable computing environment and is not intended to suggest any limitation as to the scope of use or functionality of any of the embodiments. The computing environment 1000 is not to be interpreted as having any dependency or requirement relating to any one or combination of components illustrated in the exemplary operating environment 1000.

With reference to FIG. 10, an exemplary remote device for implementing one or more embodiments herein can include a general purpose computing device in the form of a handheld computer 1010. Components of handheld computer 1010 may include, but are not limited to, a processing unit 1020, a system memory 1030, and a system bus 1021 that couples various system components including the system memory to the processing unit 1020.

Computer 1010 typically includes a variety of computer readable media and can be any available media that can be accessed by computer 1010. The system memory 1030 may include computer storage media in the form of volatile and/or nonvolatile memory such as read only memory (ROM) and/or random access memory (RAM). By way of example, and not limitation, memory 1030 may also include an operating system, application programs, other program modules, and program data.

A user may enter commands and information into the computer 1010 through input devices 1040 A monitor or other type of display device is also connected to the system bus 1021 via an interface, such as output interface 1050. In addition to a monitor, computers may also include other peripheral output devices such as speakers and a printer, which may be connected through output interface 1050.

The computer 1010 may operate in a networked or distributed environment using logical connections to one or more other remote computers, such as remote computer 1070. The remote computer 1070 may be a personal computer, a server, a router, a network PC, a peer device or other common network node, or any other remote media consumption or transmission device, and may include any or all of the elements described above relative to the computer 1010. The logical connections depicted in FIG. 10 include a network 1071, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices, networks and advertising architectures, the underlying concepts may be applied to any network system and any computing device or system in which it is desirable to publish, build applications for or consume data in connection with interactions with a cloud or network service.

There are multiple ways of implementing one or more of the embodiments described herein, e.g., an appropriate API, tool kit, driver code, operating system, control, standalone or downloadable software object, etc. which enables applications and services to use the infrastructure for information as a service from any platform. Embodiments may be contemplated from the standpoint of an API (or other software object), as well as from a software or hardware object that facilitates provision of an infrastructure for information as a service from any platform in accordance with one or more of the described embodiments. Various implementations and embodiments described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it is noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter can be appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

While in some embodiments, a client side perspective is illustrated, it is to be understood for the avoidance of doubt that a corresponding server perspective exists, or vice versa. Similarly, where a method is practiced, a corresponding device can be provided having storage and at least one processor configured to practice that method via one or more components.

While the various embodiments have been described in connection with the preferred embodiments of the various figures, it is to be understood that other similar embodiments may be used or modifications and additions may be made to the described embodiment for performing the same function without deviating there from. Still further, one or more aspects of the above described embodiments may be implemented in or across a plurality of processing chips or devices, and storage may similarly be affected across a plurality of devices. Therefore, the present invention should not be limited to any single embodiment, but rather should be construed in breadth and scope in accordance with the appended claims.

What is claimed is:

1. A method to teach geographic-specific content, comprising:
employing a processor to execute computer executable instructions stored on a computer readable storage medium to implement the following acts:
soliciting a response to a geographic-specific task;
evaluating the response;
adjusting a set of reward units based on an accuracy of the response; and
facilitating a virtual travel experience according to the accuracy of the response.

2. The method according to claim 1, wherein the soliciting comprises soliciting a plurality of responses respectively corresponding to a plurality of geographic-specific tasks.

3. The method according to claim 2, further comprising varying a task type associated with each of the plurality of geographic-specific tasks.

4. The method according to claim 3, wherein the task type is at least one of a geographic-specific question, a geographic-specific dance, or a geographic-specific language translation.

5. The method according to claim 1, further comprising ascertaining a partial accuracy of the response.

6. The method according to claim 1, wherein the facilitating further comprises providing a virtual vehicle.

7. The method according to claim 1, wherein the facilitating further comprises providing a virtual geographic-specific transportation mechanism.

8. A computer-readable storage medium that facilitates teaching geographic-specific content, comprising:
computer-readable instructions, the computer-readable instructions including instructions for causing at least one processor to perform the following acts:
receive an input responding to a geographic-specific task;
ascertain an accuracy of the input;
update a set of reward units based on the accuracy of the input; and
display a virtual travel experience, wherein aspects of the virtual travel experience vary according to the accuracy of the input.

9. The computer-readable storage medium of claim 8, further comprising instructions to receive a plurality of inputs respectively corresponding to a plurality of users.

10. The computer-readable storage medium according to claim 8, further comprising instructions to vary a task type associated with the geographic-specific task.

11. The computer-readable storage medium according to claim 10, wherein the task type is at least one of a geographic-specific question, a geographic-specific dance, or a geographic-specific language translation.

12. The computer-readable storage medium according to claim 8, further comprising instructions to determine a partial accuracy of the input.

13. The computer-readable storage medium according to claim 8, further comprising instructions to upgrade a virtual vehicle according to an aggregation of the set of reward units.

14. A computer-readable storage medium that facilitates teaching geographic-specific content, comprising:
computer-readable instructions, the computer-readable instructions including instructions for causing at least one processor to perform the following acts:
receive a plurality of inputs respectively corresponding to a plurality of geographic-specific tasks;
determine an accuracy of at least one of the plurality of inputs; and
display a virtual travel experience, wherein aspects of the virtual travel experience vary according to the accuracy of the at least one input.

15. The computer-readable storage medium of claim 14, further comprising instructions to aggregate a set of reward units based on an aggregated accuracy of the plurality of inputs.

16. The computer-readable storage medium according to claim 15, further comprising instructions to output the set of reward units to an external website.

17. The computer-readable storage medium according to claim 10, wherein the geographic-specific task is performing a geographic-specific dance.

18. The computer-readable storage medium according to claim 10, wherein the geographic-specific task is performing a geographic-specific language translation.

19. The computer-readable storage medium according to claim 1, further comprising instructions to upgrade a virtual vehicle according to an aggregated accuracy of the plurality of inputs.

20. The computer-readable storage medium according to claim 1, further comprising instructions to vary a difficulty of the plurality of geographic-specific tasks according to an aggregated accuracy of the plurality of inputs.
